(19) United States
(12) Patent Application Publication
(10) Pub. No.: US 2012/0116797 A1
(43) Pub. Date: May 10, 2012

(54) METHOD AND SYSTEM FOR CONDUCTING A HEALTH RISK ASSESSMENT

(76) Inventors: Victor J. Strecher, Ann Arbor, MI (US); Steven J. Catani, Athens, GA (US); Mary Jo Cartwright, Pinckney, MI (US); Monte Montgomery, Washington, DC (US); Thomas E. Sox, Ambler, PA (US); Cathleen S. Marsh, Cincinnati, OH (US); Janet H. Greenhut, Ann Arbor, MI (US)

(21) Appl. No.: 13/274,608

(22) Filed: Oct. 17, 2011

Related U.S. Application Data
(60) Provisional application No. 61/394,570, filed on Oct. 19, 2010.

(51) Int. Cl. G06Q 50/22

(52) U.S. Cl. 705/2

(57) ABSTRACT

A method and system for conducting a health risk assessment of one or more individuals are disclosed. In accordance with the method and system, previous responses by multiple users are used to generate specific inquires for the individual to provide specific recommended action to the individual.

### CROSS-REFERENCE TO RELATED APPLICATIONS

This application claims priority from U.S. Provisional Applications Ser. No. 61/394, 570 filed Oct. 19, 2010, the contents of each of which are hereby incorporated by reference in their entirety.

### FIELD OF THE INVENTION

The present invention relates to a method and system for conducting a health risk assessment, and providing tailored advice to the user that draws upon historical data derived from other users of this health risk assessment tool, or similar tools.

### BACKGROUND OF THE INVENTION

The health risk assessment (or HRA) is a commonly used tool for determining the health risk factors of an individual, as well as predicting future morbidity and mortality of the individual. The HRA was originally intended to determine the factors that predicted the life expectancy of an individual. This type of assessment has been in use for at least 30 years, and its predictive potential was based on various long-term epidemiological studies involving large numbers of subjects. These studies assessed health status parameters with survey questions as well as direct physiological measurements. The data collected from the subjects were compared with development of disease and the eventual death of these individuals. This analysis provided information correlating specific behavioral and physiological factors with disease development and lifespan. A comprehensive discussion of this type of HRA is provided in “Comparing the Predictive Accuracy of Health Risk Appraisal: The Centers for Disease Control Versus Carter Center Program” (J. A. Gazmararian, et al., American Journal of Public Health, 81:1296-1301 (1991)), which in incorporated herein by reference.

Subsequent development of HRAs moved beyond the primarily passive nature of earlier HRAs, and incorporated queries to determine the desire of the individual to change potentially detrimental behaviors, the degree of readiness of the individual to make the indicated changes, and the strength of the belief that the individual could make successful behavior changes. Research on more effective health promotion and the advent of more economical digital processing facilitated these improvements to HRAs.

The present invention provides a means for instantly analyzing the query responses provided by a user and comparing these with responses from prior users, thereby altering and reducing the additional queries posed to the user. The present invention also draws on the health and non-health outcomes achieved by previous users in order to tailor the guidance provided to the user.

### SUMMARY OF THE INVENTION

The present invention provides an improved method and system for conducting an HRA. One element of this invention is the incorporation of tools to identify an individual's personal objectives, and tailor health changes stimuli that are most likely to be successful, based on these objectives. The individual's personal objectives may be health related, or they may result from other motivations, including familial, social, and financial interests. Determination of the individual's objectives for achieving health change can be used for specific tailoring of health messages, and can provide a strong motivation to the individual. Also, a targeted questioning approach is used. Typically, earlier HRA's have included large numbers of questions that were of little relevance to the specific health needs of a given individual. Inclusion of these questions with little or no value resulted in time wasted by the user, as well as the potential development of boredom or frustration by the user. This could lead to reduced quality of the input provided by the user, or even premature termination of the HRA completion. This targeted questioning approach is made possible in part by analysis of query inputs provided by previous users of the particular HRA, data on the motivations of the previous users, and outcomes data for earlier users captured by ongoing health monitoring programs. These various types of collected data can be analyzed to predict which specific actions will be most effective in permitting an individual to achieve the identified objectives. In addition to providing a unique benefit at the individual level, the method and system of the invention permit risks to be assessed at a population level and allow deployment of targeted organizational initiatives to promote wellness.

The method and system of the invention pose a series of queries to an individual to determine his or her personal objective in achieving health status change. These queries involve quality of life (QOL), disease prevention, health care costs, particularly the future financial burden that health issues are likely to pose, and the energy needed to perform everyday tasks or maintain workplace productivity. The objective desired by the individual is tailored to a form that can be articulated by the individual; to be effective, the objective must be expressed in a form that is readily ownable by the individual.

The method and system of the invention incorporate four steps to drive effective action by the individual. These steps are (1) assessment of behaviors, (2) helping the individual face the reality posed by his or her health status, (3) presenting two or more alternative potential future health scenarios to the individual and guiding them through the process of making a choice, and (4) taking advantage of the individual's concern and attention at the time of presenting this choice, with the likely heightened sense of concern, to elicit a commitment to action.

One aspect of the present invention comprises a system for implementing the described HRA. The system may include standard components of an interactive computational device. One component may be an input device such as a keyboard, touch screen, or microphone accessing speech recognition software. A second component may be a data storage device, which may be a hard drive, fixed memory such as a flash drive, laser-based read/write disks or other device capable of accepting, storing, and retrieving electronic information. The data storage device may be in close proximity to the input device, or it may be at a remote location, with access provided by the internet, a telephone link, a wireless link, or other communication channel.

A third component may be a computational device such as a computer or data processor. This component is capable of accessing data from the input device, the data storage device, or other sources, and is able to operate the software modules needed to execute the various aspects of this invention. These software modules, which include various algorithms and rules engines, are also capable of drawing upon databases of query responses and health or non-health outcomes of previous users of the HRA, and comparing responses of the immediate user of the HRA with this historical data on previous users. Finally, the computational device is able to transfer output data to one or more data storage devices, or directly to an output device. The output device may consist of a video screen, a printer, an audio speaker, or other device capable of providing a communication to the individual completing the HRA.

In one embodiment, a desktop or laptop computer may be employed. It may also be a work station or terminal linked to remote data processing and data storage functions. Also, a mobile electronic device, such as a cell phone, a personal digital assistant, or a netbook may be employed. Furthermore, a telephone (either cellular or land line) that is in communication with remote data storage and data processing components may be employed. The telephone in this instance may serve as both the input and output components.

The invention, as described above, may be based on the responses of a single individual to the HRA. However, the invention may be similarly based on responses of groups of individuals, for example a couple or a family unit.

The invention uses responses of an individual to HRA queries to provide suggested activities for achieving positive health changes. However, in addition to responses obtained directly from the individual, it may also draw on “360 degree” feedback obtained from the family, acquaintances, or coworkers of the individual. This information provides other perspectives on the health issues and motivational status of the individual, and improves the overall accuracy and predictive ability of the HRA output to the individual.

### BRIEF DESCRIPTION OF THE DRAWINGS

FIG. 1 is a block diagram showing a system for administering a HRA to a target population, and collecting responses to the HRA queries that may be employed when using the method of the present invention.

FIG. 2 is a block diagram showing a system for administering a HRA to an individual, collecting responses to the queries, and recommending actions to the individual for achieving one or more identified objectives that may be employed when using the method of the present invention.

FIG. 3 is a block diagram showing a system for administering a HRA to an individual, collecting responses to the queries, and recommending actions to the individual for achieving one or more identified objectives similar to that in depicted in FIG. 2, but additionally incorporating a determination of the primary objective, either health or non-health related, of the individual for achieving a health improvement that may be employed when using the method of the present invention.

FIG. 4 is a block diagram showing a controller that may be used to implement some aspects of the present invention.

### DETAILED DESCRIPTION OF THE PREFERRED EMBODIMENTS

Unless defined otherwise, all technical and scientific terms used herein have the same meaning as commonly understood by one of ordinary skill in the art to which the invention belongs. Also, all publications, patent applications, patents, and other references that may be mentioned herein are incorporated by reference in their entirety.

The present invention relates to a method and system for conducting a health risk assessment, or HRA, and providing to the individual completing the HRA specific guidance for achieving a relevant objective, which may be health-related, or not related to health. The invention thus includes a component for evaluating the basic motivations of an individual, and assessing their willingness to attempt various behavioral or lifestyle changes. This component may also predict their likelihood of success in achieving these changes and their determined objectives.

The present invention also relates to administering one or more HRAs to a target population of individuals, and collecting responses. It also incorporates evaluation of the success of members of a target population in achieving health state changes, and correlating these changes with various patterns of HRA responses. Additionally, a separate second target population may be used as a source of data on success in achieving healthcare change, and members of the second population may be linked to members of the first population for the purpose of analysis by, e.g., epidemiological, sociological, cultural, genetic, or phenotypic factors and variables. The results of these analyses are incorporated into rules operating on rules engine, which is included in software operating on a processing device, such as a mainframe computer, a desktop computer, a laptop computer, or a hand-held computational device such as a personal digital assistant or a cell phone. These rules may be stored in a data storage device, or alternatively, the rules may be generated real time during the administration of the HRA to a new user.

The rules generated by this analysis can serve a number of purposes. One purpose is to generate additional queries to the new user that are based on the previous query responses of the user. These additional queries may be particularly useful in providing details of the motivations and objectives of the individual, and determining possible actions that will be most effective for the individual. Also, the real time analysis of the responses to queries by the user, and possible comparison with past associations as contained in the rules engine, may allow the elimination of non-useful or duplicative additional queries to the user. This streamlining of the HRA and elimination of non-useful queries reduces the time needed to complete the HRA, reduces the potential frustration of the user in participating in the HRA, and improves the overall quality of the output that is provided to the user.

Another aspect of the invention is the use of data from previous users of the HRA, or other versions of the HRA, to determine correlations among various query responses, the recommended actions that were provided to users based on their query responses, and the degree of success that individuals achieved in implementing these recommendations and achieving one or more health or non-health objectives. This information comprises a database of health change outcomes that is maintained in a form of an electronic data storage device. These various correlations are used to construct rules that are incorporated within a rules engine operating on a processing device. This processing device receives the query responses from an individual completing the HRA, applies the rules engine derived from past history HRA users, and selects the health change actions that are predicted to be most effective for the individual completing the HRA. These recommendations are transmitted to an output device, such as a video screen, which is accessible to the user.

According to another embodiment of the invention, diagnostic psychology queries are used to determine the motivational behavior of the individual completing the HRA. These queries are designed to determine the fundamental objectives of the individual in achieving a change in a health state. These queries may be used prior to participation of the individual in the HRA, or alternatively may be administered concurrently with the HRA. The one or more fundamental objectives identified may be health-related objectives, or they may be objectives not related to health. These non-health related objectives may be related to financial concerns, receipt of rewards, or intellectual or emotional objectives.

The following detailed description uses terms such “input device,” “output device,” “data storage device,” “rules engine,” and “processing device.” These terms should be construed in the broadest sense, and are not limited by the specific examples of this disclosure.

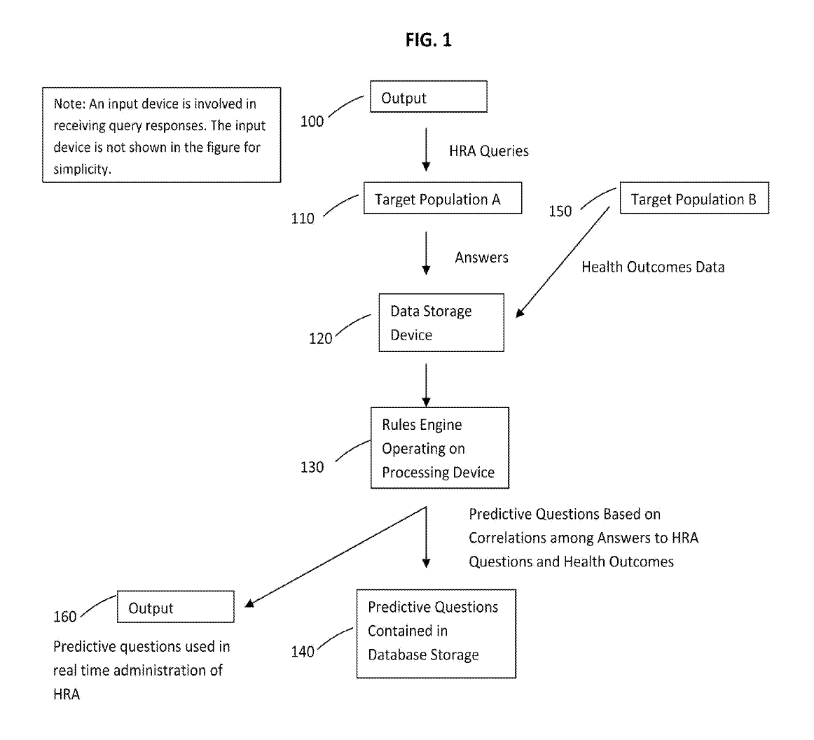

Referring now to FIG. 1, a block diagram represents a system for administering a HRA to a target population, and collecting responses to the HRA queries. Health or non-health outcome data are obtained for the same target population, or another target population. Query responses for individuals, and the health or non-health outcome of the same or similar individuals, are used to construct rules for providing predictive questions for inclusion in future administrations of a HRA. The rules function within a rules engine that operates on processing device. The generated predictive questions are either generated in real time and provided to an individual to whom the HRA is being administered, or retained in a data storage device for later use.

More specifically, FIG. 1 depicts an output device 100 that provides HRA queries to a target population A 110. The target population A 110 provides responses to these queries via an input device (not shown). Data containing the responses are transferred from the input device (not shown) to a data storage device 120. Additionally, health outcome data are obtained from a target population B 150 and transferred to the data storage device 120. The health outcome data includes experiences of individuals who have received guidance from an interactive HRA, or similar individuals. The target population B 150 may include the same individuals as included in target population A 110, a portion of the individuals in target population A 110, a totally distinct population of individuals, or a combination of some or all target population A 110 and one or more additional individuals. The response data and the health outcome data maintained in the data storage device 120 are analyzed by a rules engine operating on processing device 130. The rules engine processes these data to generate predictive questions based on obtained correlations among HRA response data and health outcome data. The predictive questions produced by the processing device 130 are transferred to data storage device 140 for use in future administration of HRA's, or they may be immediately transferred to an output device 160 for use in real time administration of a HRA.

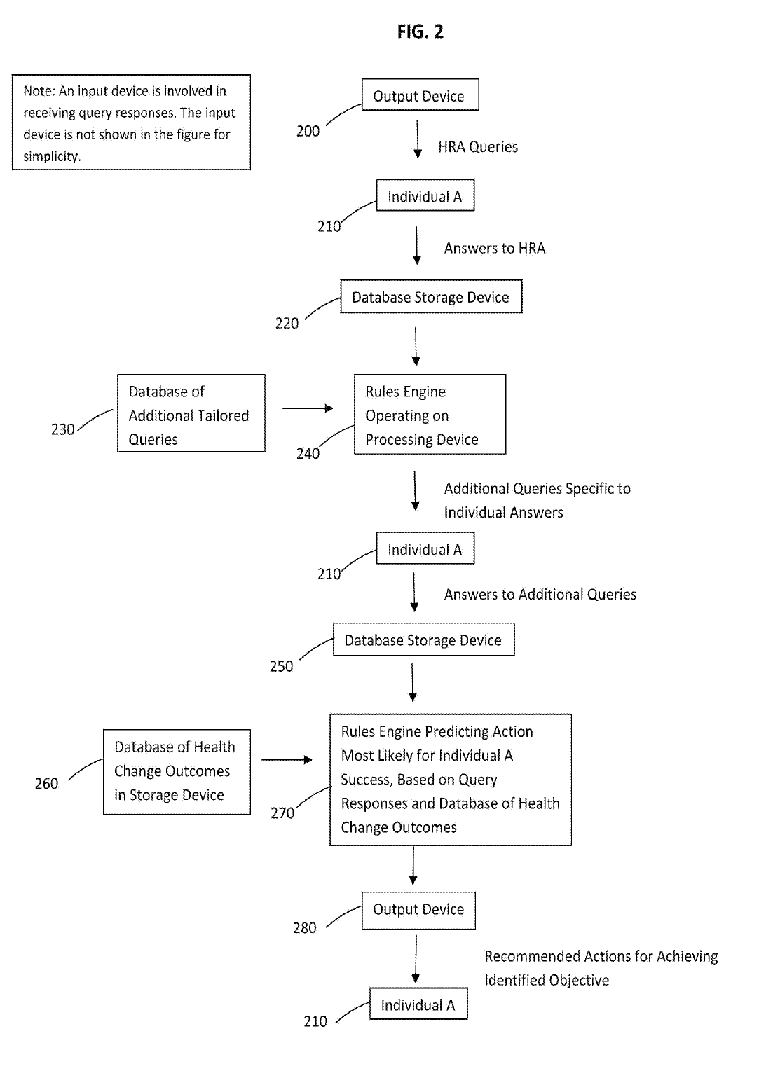

Referring now to FIG. 2, a block diagram of a system for administering a HRA to an individual, collects responses to the queries, and recommends actions to the individual for achieving one or more identified objectives. A rules engine operating on a processing device analyzes the query responses in real time, and utilizes a database of additional tailored queries to obtain additional information from the individual. The tailored questions obtain information that will improve the likelihood that the provided recommended actions will result in achievement of the one or more objectives, while minimizing the redundant or non-useful queries to which the individual is exposed.

More specifically, FIG. 2 depicts an output device 200 that provides HRA queries to an individual A 210. Individual A 210 provides responses to the queries via an input device (not shown) that transfers the responses to the queries to a data storage device 220. A rules engine operating on a processing device 240 analyzes the query responses obtained from data storage device 220. Based on the operation of the rules engine, the rules engine may select additional queries to pose to individual A 210, and may optionally select additional queries from a database of additional tailored queries 230 to pose to individual A 210. These additional queries may be the predictive questions contained in data storage device 140, from FIG. 1. Individual A 210 provides responses to these additional queries via an input device (not shown) to a data storage device 250. The stored data from data storage device 250 and data stored in a database of health change outcomes in data storage device 260 are accessed by a rules engine operating on processing device 270 to predict one or more actions most likely to help the individual to be successful. These recommended actions are transferred to an output device 280, which communicates the recommended actions to individual A 210.

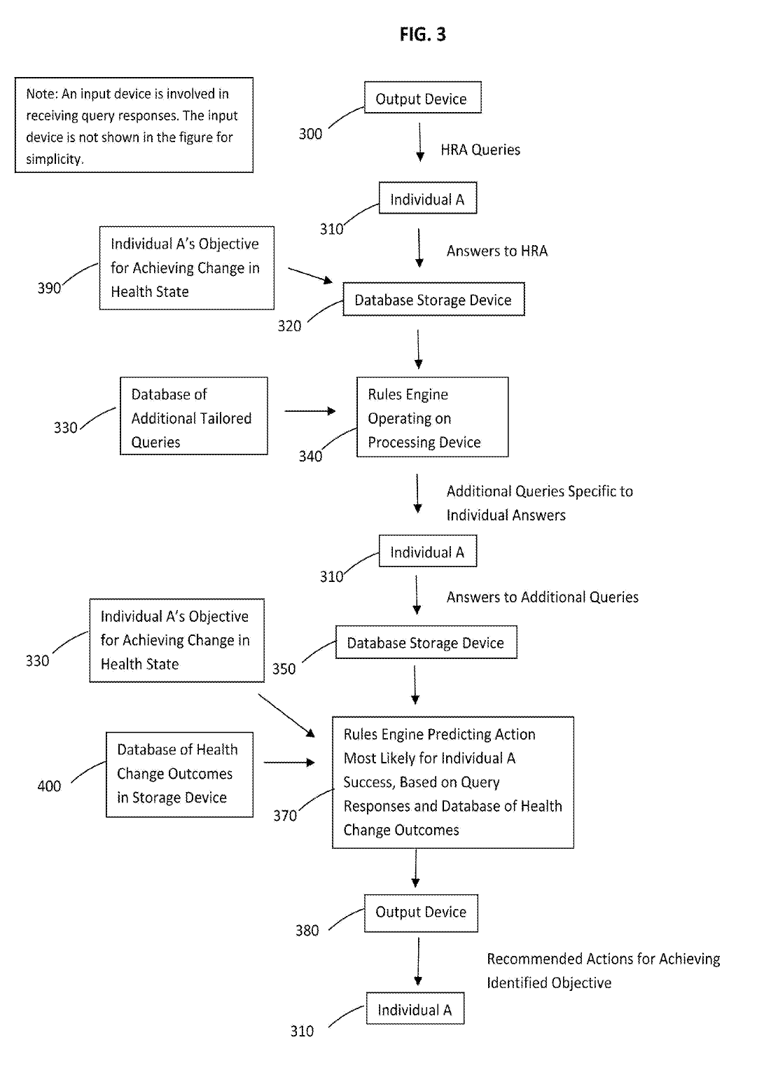

Referring now to FIG. 3, a block diagram showing a system for administering a HRA to an individual by collecting responses to queries and recommending actions to the individual for achieving one or more identified objectives similar to that in depicted in FIG. 2, but additionally incorporating a determination of the primary objective, either health or non-health related, of the individual for achieving a health improvement.

More specifically, FIG. 3 describes the operation of the invention in a manner similar to that operation shown in FIG. 2. That is to say, an output device 300 provides HRA queries to an individual A 310. Individual A 310 provides responses to the queries via an input device (not shown) that transfers the responses to the queries to a data storage device 320. FIG. 3 has the addition of an input containing the individual's primary objective or objectives for achieving a change in health state 390 to data storage device 320. The individual's primary objective input may be derived from the information determined by the HRA, or alternatively this input may be obtained from additional testing of the individual, interviews of the individual, or information spontaneously provided by the individual. This additional input is accessed by the rules engine operating on processing device 340, and may be used in the selection of additional HRA queries posed to the individual. Based on the operation of the rules engine, the rules engine may select additional queries to pose to individual A 310, and may optionally select additional queries from a database of additional tailored queries 330 to pose to individual A 310. Individual A 310 provides responses to these additional queries via an input device (not shown) to a data storage device 350. The stored data from data storage device 350 are accessed by rules engine operating on processing device 370 to predict one or more actions most likely to help the individual to be successful. FIG. 3 also contains the additional element of individual A's one or more objectives for achieving change in health state 395 serving as an input to the rules engine predicting action most likely for individual A success 370. The objectives in 395 may be the same as, partially different from or totally distinct from the objectives in 390. This additional input to the rules engine 370 permits greater ability to tailor the recommended actions and guidance provided to the individual, and increases the likelihood of the individual achieving success in improving health and attaining the personal objectives. These recommended actions are transferred to an output device 380, which communicates the recommended actions to individual A 310.

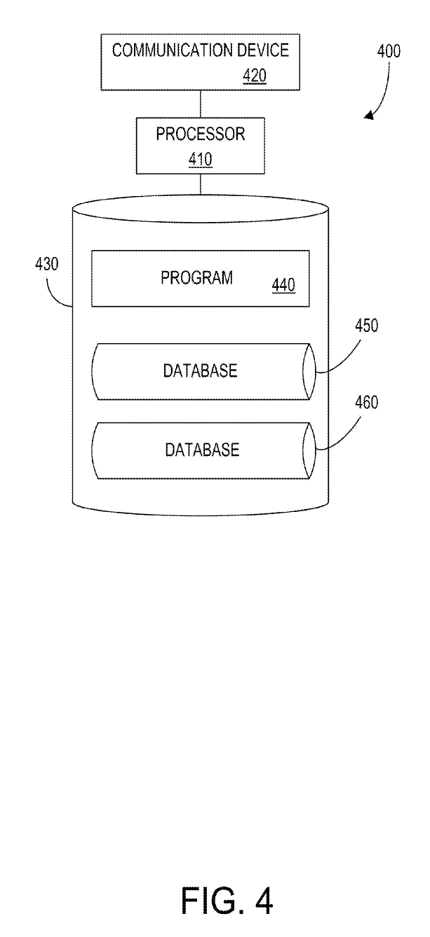

Referring now to FIG. 4, a controller 400 that may be used to implement some aspects of the present invention contains a processor unit 410, which may include one or more processors, coupled to a communication device 420 configured to communicate via a communication network (not shown). The processor 410 is also in communication with a data storage device 430. The data storage device 430 may comprise any appropriate information (data) storage devices, including combinations of magnetic storage devices (e.g., magnetic tape and hard disk drives), optical storage devices, and/or semiconductor memory devices such as Random Access Memory (RAM) devices and Read Only Memory (ROM) devices.

The data storage device 430 can store executable software programs 440 for controlling the processor 410. The processor 410 performs instructions of the executable software program 440, and thereby operates in accordance with the present invention. The data storage device 430 may also store related data in one or more databases 450, 460.

The foregoing examples are not intended to limit the scope of the present invention, which may be set out in the claims. In particular, various equivalents and substitutions will be recognized by those skilled in the art in view of the foregoing disclosure and these are contemplated to be within the scope of the invention.

What is claimed is:

1. A system for conducting a health risk assessment, the system comprising:
controller comprising a processor and a storage for digital data;
an input device suitable for receiving input from a person;
an output device displaying content in a human readable medium; and
executable software stored on the storage for digital data and executable on demand, the executable software operative with the processor to cause the system to:
present one or more initial queries to an individual to ascertain one or more principle objectives of the individual in mitigating one or more health risks,
execute a first rules engine containing rules derived from previous responses provided by multiple users, wherein the first rules engine analyzes in real time one or more responses provided by the individual to said one or more initial queries, whereby the first rules engine selects, based on the responses provided by the individual, additional questions that are predictive in obtaining useful health risk assessment information;
select additional queries sufficient to maintain a predictive value of the health risk assessment and also limit a total number of queries posed;
display the additional queries to the individual via the output device;
access a database of health change experiences and outcomes, said database being contained in the data storage device, and comprising data related to health and non-health outcomes of previous users of the system,
apply a rules engine operating on the controller to compare information obtained from the queries posed to the individual to the health and non-health outcomes database, thereby selecting the one or more actions most likely to be successful in achieving the identified objective of the individual, and
communicate to the individual via the output device a determined one or more actions.

2. The system of claim 1, further comprising an additional rules engine, operating via the executable software, wherein the additional rules engine is operative with the processor to:
identify a population of users with a specific health risk; and
communicate to one or more subgroups of the population possessing the health risk, one or both of: an organizational initiative and a motivational driver.

3. The system of claim 2 wherein the one or more subgroups of the population possessing the health risk comprises an entire portion of the population with the health risk

4. The system of claim 1, wherein communication by the output device of the one or more actions comprises at least two alternate future states.

5. The system of claim 4 wherein the at least two alternate future states comprise one future state depicting a likely health outcome of an individual if the provided one or more actions are taken, and one future state depicting a possible health outcome of an individual if the one or more actions are not taken.
